(19) United States
(12) Patent Application Publication
(10) Pub. No.: US 2007/0124641 A1
(43) Pub. Date: May 31, 2007

(54) Method of improving network layer performance for a wireless station

(76) Inventor: Chih-Hao Yeh, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/164,091

(22) Filed: Nov. 10, 2005

(51) Int. Cl. H04L 1/18

(52) U.S. Cl. 714/749

(57) ABSTRACT

A method for queuing data frames for improving network layer performance in wireless stations is provided. The method includes loading data frames to be transmitted from a transmitting wireless station into a hardware transmission queue; transmitting the data frames in the hardware transmission queue one data frame at a time; receiving acknowledgements of transmitted data frames; resending data frames that have not received a corresponding acknowledgement within a predetermined period of time of their transmittal; counting the number of times that each unacknowledged data frame has been transmitted without receiving an acknowledgment and generating a count value for each unacknowledged data frame; marking unacknowledged data frames having a count value greater than a predetermined value as undeliverable data frames; and putting the undeliverable data frames and subsequent data frames to be transmitted to the same target addresses into a software transmission queue for later transmission.

### BACKGROUND

The invention relates to wireless networks, and more particularly, to a method of improving network layer performance in wireless stations by queuing packets being sent to a station that is temporarily unreachable.

Traditionally, network layer protocol assumes a loss of packets due to network congestion. The network congestion can be caused by a variety of factors, such as limitations in the channel bandwidth or the capacity of a router. If packet loss is detected, the network layer protocol usually slows down the transmitting station's packet generation rate in order to alleviate the network traffic load.

However, for wireless data links, such as a wireless local area network (WLAN) conforming to the IEEE 802.11 specification, the loss of packets may come from the nature of the wireless medium. The signal may be temporarily disrupted by noise, the receiving station may have switched to another radio frequency (RF) channel, or the receiving station may have even turned off RF reception temporarily.

Please refer to FIG. 1. FIG. 1 is a diagram illustrating acknowledgments of data frames. A transmitting station 10 sends a first set of data frames 20 to a receiving station 12, and the receiving station 12 responds with an acknowledgment 22. Knowing that the first set of data frames 20 has been received, the transmitting station 10 then sends out a second set of data frames 24 to the receiving station 12. FIG. 2 shows another situation, in which an acknowledgment is not received within a time out period. The transmitting station 10 sends a first set of data frames 30 to the receiving station 12, but does not receive an acknowledgment within a period of time representing a time out period. This may be because the receiving station 12 did not receive the first set of data frames 30. On the other hand, the receiving station 12 may have received the first set of data frames 30 and sent out an acknowledgement 32, but the acknowledgement 32 was not received by the transmitting station 10. In either case, the data frames are retransmitted as a new set of data frames 34.

Data link layer hardware, such as a network interface card (NIC), usually maintains a hardware queue capable of queuing several frames. When the first frame has reached its transmission limit, the NIC still tries to transmit every frame after the failed frame in the hardware queue, even if the target station of the subsequent frames are the same as the target station of the failed frame. The subsequent frames intended for the same target station as the failed frame usually fail to reach the target station as well, which causes a loss of packets. In order to recover from this loss of packets, the network layer needs to employ costly network layer retransmission, which slows down the overall packet generation rate.

### SUMMARY

Methods and systems for improving network layer performance in wireless stations are provided. An exemplary embodiment of a method for queuing data frames for improving network layer performance in wireless stations comprises: loading data frames to be transmitted from a transmitting wireless station into a hardware transmission queue, each of the data frames comprising a target address indicating a destination wireless station; transmitting the data frames in the hardware transmission queue one data frame at a time; receiving acknowledgements of transmitted data frames; resending data frames that have not received a corresponding acknowledgement within a predetermined period of time of their transmittal; counting the number of times that each unacknowledged data frame has been transmitted without receiving an acknowledgment and generating a count value for each unacknowledged data frame; marking unacknowledged data frames having a count value greater than a predetermined value as undeliverable data frames and marking the corresponding target addresses as an undeliverable target addresses; and putting the undeliverable data frames and subsequent data frames to be transmitted to the undeliverable target addresses into a software transmission queue for later transmission.

An exemplary embodiment of a data frame transmission system for a wireless station is disclosed. The data frame transmission system comprises: a hardware transmission queue for storing data frames to be transmitted, each of the data frames comprising a target address indicating a destination wireless station; transmission hardware for transmitting the data frames in the hardware transmission queue one data frame at a time, for receiving acknowledgements of transmitted data frames, and for resending data frames that have not received a corresponding acknowledgement within a predetermined period of time of their transmittal; a counter for counting the number of times that each unacknowledged data frame has been transmitted without receiving an acknowledgment and generating a count value for each unacknowledged data frame; a controller for marking unacknowledged data frames having a count value greater than a predetermined value as undeliverable data frames and marking the corresponding target addresses as an undeliverable target addresses; and a software transmission queue for storing for later transmission the undeliverable data frames and subsequent data frames to be transmitted to the undeliverable target addresses.

### BRIEF DESCRIPTION OF THE DRAWINGS

FIG. 1 is a diagram illustrating acknowledgments of data frames.

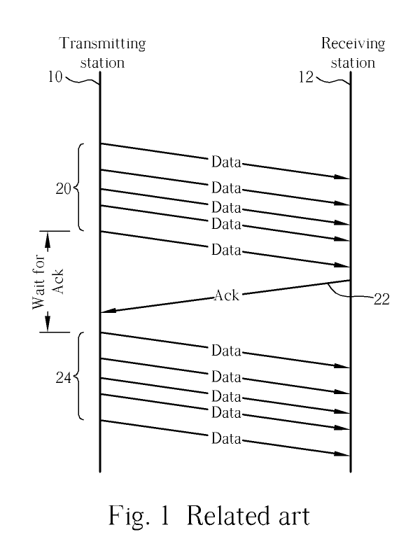

FIG. 2 is a diagram illustrating a situation in which an acknowledgment is not received within a time out period.

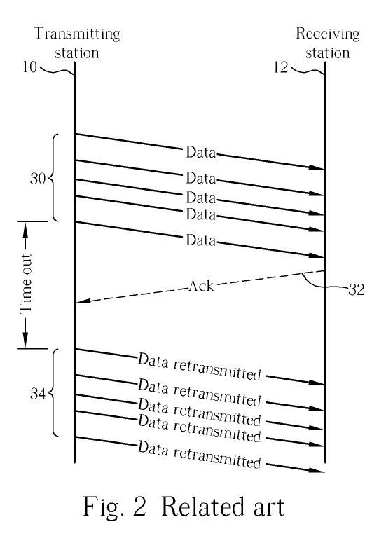

FIG. 3 is a block diagram of a data frame transmission system for a wireless station.

FIG. 4 is an example illustrating the handling of data frames in a hardware transmission queue.

### DETAILED DESCRIPTION

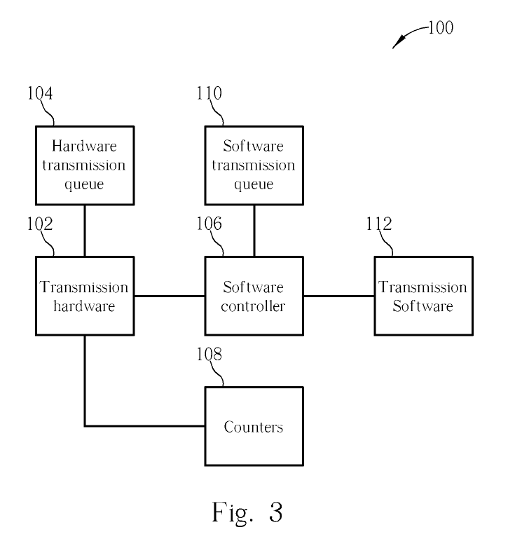

In order to temporarily store data frames intended for a target address that is currently unavailable, a software transmission queue is used. Please refer to FIG. 3, which is a block diagram of a data frame transmission system 100 for a wireless station. The system 100 contains transmission hardware 102 and a hardware transmission queue 104 residing in data link layer hardware, such as a network interface card (NIC). In addition, the system 100 contains a software controller 106, a set of counters 108, a software transmission queue 110, and transmission software 112 executed by the software controller 106.

The system 100 contains the necessary structure used by a transmitting station to send data frames to a receiving station. When the transmitting station contains data frames to be sent, the data frames are stored in the hardware transmission queue 104, and the transmission hardware 102 attempts to transmit the data frames to the receiving station. The software controller 106 keeps track of whether an acknowledgement was received for each frame or each set of frames that are sent to a particular target address. The target address can be realized as a (MAC) address of the destination wireless station or as an association identity (AID) of the destination wireless station, each of which is defined by the IEEE 802.11 specification. The MAC address is a 48-bit address, whereas the AID is a 14-bit address, making the AID preferred due to its smaller size.

The set of counters 108 is used for counting the number of times a data frame has been transmitted to the target address. For a data frame that has been transmitted to the target address more than a predetermined number of times without receiving an acknowledgment, the software controller 106 will mark this data frame as an undeliverable data frame. The undeliverable data frame will be removed from the hardware transmission queue 104 and will instead be placed in the software transmission queue 110. Furthermore, the all other data frames in the hardware transmission queue 104 that have a destination address that is the same as the target address of the undeliverable frame will be marked as skipped data frames. These skipped data frames will also be removed from the hardware transmission queue 104 and will instead be placed in the software transmission queue 110. The software transmission queue 110 acts as a temporary queue for storing data frames to be sent to receiving stations that the transmitting station is temporarily unable to communicate with. In this way, the transmitting station does not need to repeatedly try to transmit data frames that will not be successfully received.

Once the transmitting station becomes aware that the receiving station that had the temporary communication problem is able to receive data frames again, the data frames with the target address corresponding to that receiving station are moved from the software transmission queue 110 back to the hardware transmission queue 104. The transmitting station can determine that the receiving station is again capable of receiving data frames in at least two ways. First, if a data frame is passively received from the receiving station, it can be concluded that the receiving station is also capable of receiving and acknowledging data frames. Second, the transmitting station can try transmitting a small test data frame to the receiving station in order to see if the receiving station acknowledges the test data frame. If an acknowledgement is received from the receiving station, the transmitting station can conclude that the receiving station is again able to receive data frames. The transmission hardware 102 can notify the software controller 106 that an acknowledgement has been received or the software controller 106 can periodically poll the transmission hardware 102 to obtain this information.

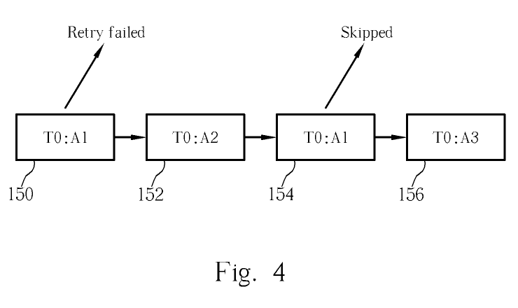

Please refer to FIG. 4. FIG. 4 is an example illustrating the handling of data frames in the hardware transmission queue 104. The example shows four data frames 150, 152, 154, 156 stored inside the hardware transmission queue 104. Data frame 150 has a target address of A1, and has already been transmitted a number of times exceeding the predetermined number of times without receiving an acknowledgment. Therefore, data frame 150 is marked as an undeliverable data frame, and is moved to the software transmission queue 110. Data frame 152 is transmitted to a target address of A2, which is different than the target address of data frame 150. In this example, since there is no problem with any receiving station other than the receiving station corresponding to the target address of A1, data frame 152 is successfully transmitted. Next in the hardware transmission queue 104 is data frame 154, which has a target address of A1. Since the target address of A1 has already had a problem of an undeliverable data frame with data frame 150, data frame 154 and all other data frames with the target address of A1 are marked as skipped for the time being, and are moved from the hardware transmission queue 104 to the software transmission queue 110. Then data frame 156, with a target address of A3, is delivered as normal.

In this example, since the transmitting station was unable to communicate with the receiving station corresponding to the target address of A1, all data frames to be transmitted to the problem receiving station are temporarily stored in the software transmission queue 110. Once the software controller 106 has determined that the problem receiving station is again able to communicate with the transmitting station, the corresponding data frames are moved back from the software transmission queue 110 to the hardware transmission queue 104. In this way, network performance is not greatly affected by a problem communicating with one or more wireless stations, and network traffic with other wireless stations can still move at a high speed. Because the software transmission queue 110 temporarily removes data frames from the hardware transmission queue 104 for later transmission, the data frame transmission system 100 outlined above is not suitable for use in real-time networking protocols. Real-time networking protocols consider packet loss to be normal, and try to minimize the delay of data transmission between wireless stations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of queuing data frames for improving network layer performance in wireless stations, the method comprising:
loading data frames to be transmitted from a transmitting wireless station into a hardware transmission queue, each of the data frames comprising a target address indicating a destination wireless station;
transmitting the data frames in the hardware transmission queue one data frame at a time; receiving acknowledgements of transmitted data frames;
resending data frames that have not received a corresponding acknowledgement within a predetermined period of time of their transmittal;
counting the number of times that each unacknowledged data frame has been transmitted without receiving an acknowledgment and generating a count value for each unacknowledged data frame;
marking unacknowledged data frames having a count value greater than a predetermined value as undeliverable data frames and marking the corresponding target addresses as an undeliverable target addresses; and
putting the undeliverable data frames and subsequent data frames to be transmitted to the undeliverable target addresses into a software transmission queue for later transmission.

2. The method of claim 1, wherein putting data frames into the software transmission queue further comprises removing the data frames from the hardware transmission queue.

3. The method of claim 1, further comprising removing data frames corresponding to a first target address from the software transmission queue and adding the removed data frames to the hardware transmission queue upon the transmitting wireless station determining that the wireless station corresponding to the first target address is capable of receiving data frames.

4. The method of claim 3, wherein the transmitting wireless station determines that the wireless station corresponding to the first target address is capable of receiving data frames upon receipt of a data frame from the wireless station corresponding to the first target address.

5. The method of claim 3, wherein the transmitting wireless station determines that the wireless station corresponding to the first target address is capable of receiving data frames by transmitting a test data frame to the wireless station corresponding to the first target address and receiving an acknowledgement of the test data frame.

6. The method of claim 1, wherein the target address in each of the data frames is a media access control (MAC) address of the destination wireless station.

7. The method of claim 1, wherein the target address in each of the data frames is an association identity (AID) of the destination wireless station.

8. A data frame transmission system for a wireless station, comprising:
a hardware transmission queue for storing data frames to be transmitted, each of the data frames comprising a target address indicating a destination wireless station;
transmission hardware for transmitting the data frames in the hardware transmission queue one data frame at a time, for receiving acknowledgements of transmitted data frames, and for resending data frames that have not received a corresponding acknowledgement within a predetermined period of time of their transmittal;
a counter for counting the number of times that each unacknowledged data frame has been transmitted without receiving an acknowledgment and generating a count value for each unacknowledged data frame;
a controller for marking unacknowledged data frames having a count value greater than a predetermined value as undeliverable data frames and marking the corresponding target addresses as an undeliverable target addresses; and
a software transmission queue for storing for later transmission the undeliverable data frames and subsequent data frames to be transmitted to the undeliverable target addresses.

9. The system of claim 8, wherein the controller removes the data frames from the hardware transmission queue when adding the data frames to the software transmission queue.

10. The system of claim 8, wherein the controller removes data frames corresponding to a first target address from the software transmission queue and adds the removed data frames to the hardware transmission queue upon determining that the wireless station corresponding to the first target address is capable of receiving data frames.

11. The system of claim 10, wherein the controller determines that the wireless station corresponding to the first target address is capable of receiving data frames upon receipt of a data frame from the wireless station corresponding to the first target address.

12. The system of claim 10, wherein the controller determines that the wireless station corresponding to the first target address is capable of receiving data frames by transmitting a test data frame to the wireless station corresponding to the first target address and receiving an acknowledgement of the test data frame.

13. The system of claim 8, wherein the target address in each of the data frames is a media access control (MAC) address of the destination wireless station.

14. The system of claim 8, wherein the target address in each of the data frames is an association identity (AID) of the destination wireless station.
